(19) United States
(12) Patent Application Publication
(10) Pub. No.: US 2005/0022397 A1
(43) Pub. Date: Feb. 3, 2005

(54) Finish carpentry trim gauge

(76) Inventor: Rodney Neblo, Onstead, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/900,005

(22) Filed: Jul. 27, 2004

Related U.S. Application Data
(60) Provisional application No. 60/490,881, filed on Jul. 29, 2003.

(51) Int. Cl. G01D 21/00

(52) U.S. Cl. 33/194

(57) ABSTRACT

A carpentry gauge of this invention includes a first and second face surface that abut interior surfaces of vertical and horizontal frame members for the window or door opening. Extending from those faces are the lip portions. The lip portions overlap the outer surface of the vertical and horizontal members of the doorframe and provide the correct distance for a desired setback. The carpentry gauge of this invention is small, compact and easily placed and carried within a shirt pocket. No adjustments are required to be made to the gauge and only one dimension is provided in each gauge eliminating possible confusion during marking for a specific window or doorframe.

This application claims priority to the provisional application Ser. No. 60/490,881 filed on Jul. 29, 2004.

### BACKGROUND OF THE INVENTION

This invention relates generally to a carpentry gauge and specifically to a carpentry gauge for defining a setback dimension for the installation of trim around a window or door opening.

Typically, of openings of windows and doors and the like to provide a roughed opening in the basic structural framing. Extra space between the outer dimension of the frame and the inner dimensions of the rough opening are adjusted with shim material. The interior walls are then typically covered with dry wall or other sheet material. This construction process produces an undesirably transition or gap between the edge of the finished wall and the frame opening. Wood trim or molding is used to cover gap and provide an aesthetically pleasing appearance around the opening for the door or window.

Preferably, an inner edge the trim is set back from an inner edge of the corresponding doorframe or window. A uniform space or set back is desirable and provides a finished appearance. Not only does a consistent setback distance about the entire opening provide an aesthetically pleasing and professionally installed appearance, it is an indicator of quality construction. Molding typically includes a mitered joint in adjoining corners such as the corner joint between the vertical and horizontal trim pieces. As it is highly desirable to provide a uniform edge distance completely around the opening, the determination of the precise measurements for the finish cuts involved in fabricating and installing such trim can become quite involved.

There are different types of gauges and measuring devices such as squares, tape measures or other devices that can be used to mark the specific setback distance from the edge of the window or doorframe. However, many of these devices are not specifically designed to create or mark a setback distance for trim around an opening. Therefore, these devices become cumbersome due to the small distances typically used for setback of trim around windows and doors. These devices are more of a general use device and are not specifically suited for measurement and marking of setback distances around window or door moldings.

There exist several known devices that have the purpose of marking a desired setback distance around a window or doorframe. When such device is adjustable in nature in order to allow the installer to set the setback distance and mark that distance on that frame. Other devices are cumbersome and require securing to the window or doorframe. Further, another device includes at least two different setback dimensions on the single block that can cause confusion due to the small differences in set back distance that are visually similar in appearance.

Accordingly, it is desirable to design and develop a finish carpentry gauge that is simple to use and allows for marking of a horizontal and vertical member at the same time.

### SUMMARY OF THE INVENTION

The present invention is a finish trim carpentry gauge for marking a set back distance along a vertical and horizontal member without readjustment of the gauge.

The carpentry gauge of this invention is a one-piece block including a first and second lip portion. The lip portions extend from the block portion a desired length. The desired length provides the desired setback distance that is marked on the window or doorframe. A carpentry gauge of this invention includes a first and second face surface that abut interior surfaces of vertical and horizontal frame members for the window or door opening. Extending from those faces are the lip portions. The lip portions overlap the outer surface of the vertical and horizontal members of the doorframe and provide the correct distance for a desired setback. The specific length of the lips can be as is desired by the application specific requirements. The carpentry gauge of this invention is small, compact and easily placed and carried within a shirt pocket. No adjustments are required to be made to the gauge and only one dimension is provided in each gauge eliminating possible confusion during marking for a specific window or doorframe.

Accordingly, the carpentry gauge of this invention provides a cost efficient, easy to use and accurate gauge for marking the setback distance for trim installed around a window or doorframe.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a perspective view of the gauge abutted against a vertical and horizontal member of a wood window or door frame;

FIG. 2 is a plan view of the bottom of the carpentry gauge;

FIG. 3 is a side view of the carpentry gauge; and

FIG. 4 is a perspective view of a gauge according to this invention abutted against a vertical and horizontal member;

FIG. 5 is a plan view of the bottom of a carpentry gauge according to this invention; and

FIG. 6 is a side view of a carpentry gauge according to this invention.

### DETAILED DESCRIPTION OF THE PREFERRED EMBODIMENT

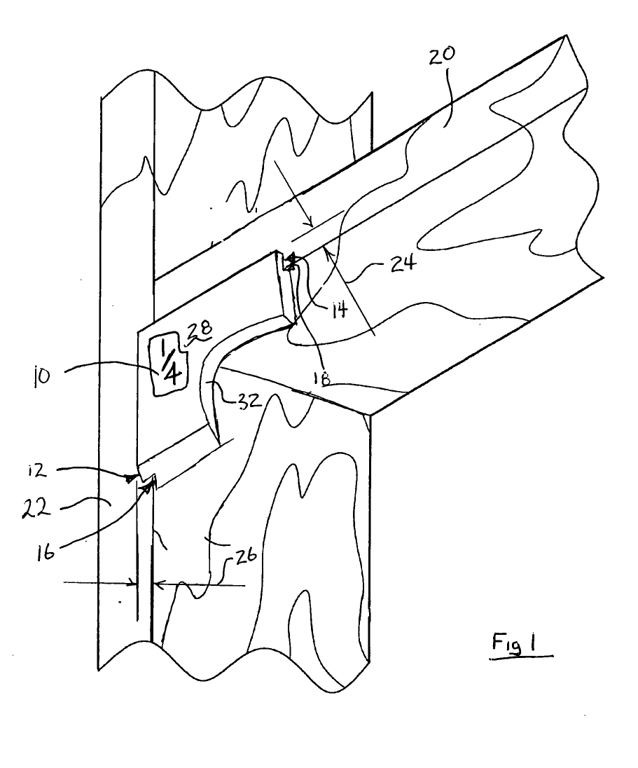

Referring to FIG. 1, a gauge 10 is shown abutted against a horizontal frame member 20 and a vertical frame member 22. The gauge 10 includes first and second lips 12 and 14. The first lip 12 overlaps the vertical frame member 22 by a pre-determined distance as indicated by the arrow 26. The lip 12 overlaps the vertical frame member 22 to provide the setback distance indicated by arrows 26. The same setback distance is provided by the second lip 14 along the horizontal frame member 20 as indicated at 24. Preferably, the set back distance is ¼ inch or 3/16^{th} of an inch. However, the specific dimension of the first and second lips 12, 14 can be of any length corresponding to a desired setback for the trim.

The gauge is a generally L-shaped block including first and second faces 16, 18. Each of the faces 16, 18 abut an exterior surface of the vertical and horizontal frame members 20, 22. The generally L-shaped gauge 10 will face into an abutting corner of the horizontal and vertical members 20, 22. Abutting the first and second faces 16 and 18 with corresponding vertical and horizontal members 20, 22, provides a secure and tight fit to assure the proper setback dimensions 24, 26 are accurately and reliably set for each corner of the window or door opening.

The gauge 10 provides for relatively simple and effective means of marking a desired setback distance for trim and molding installed around a door or window frame. Gauge 10 is in a compact design and L-shaped. The L-shaped gauge 10 includes a top surface 28. The top surface 28 can be marked to identify the specific setback distance for that particular gauge 10 such as “3/16ths” or “¼” that is provided by the particular gauge 10. This enables a worker skilled in the art to quickly identify the proper gauge 10 for use in a specific application. A marking indicating the setback distance that that particular gauge provides on the top surface 28 eliminates confusion that can be created by gauges with multiple setback distances.

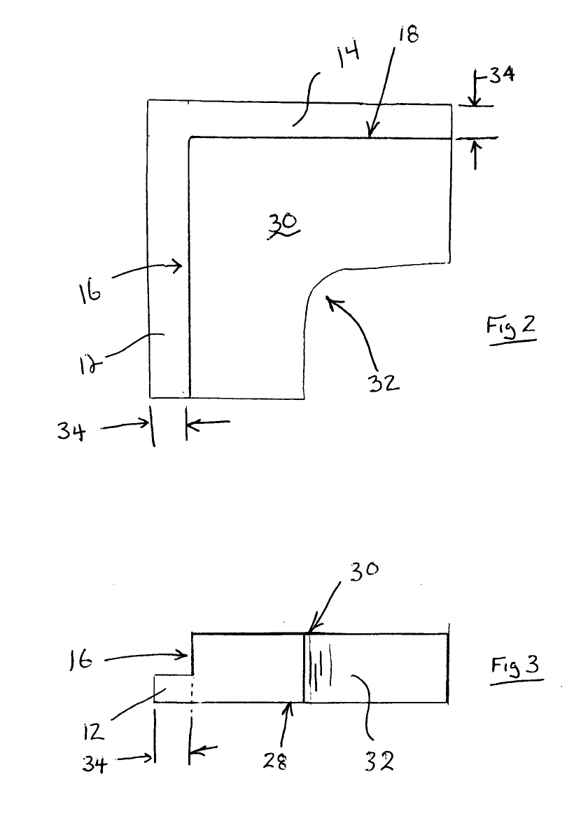

Referring to FIGS. 2 and 3, the gauge 10 is shown to indicate the simple construction and configuration. The gauge 10 includes the first and second faces 16 and 18 that abut corresponding vertical and horizontal members 20, 22 at the abutting corners of the window or doorframe. The gauge 10 is preferably fabricated as an L-shaped block. The L-shaped block includes a curved section 32. This curved section 32 aids in gripping and forcing the gauge into the abutting corner of the door or window frame. First and second lips 12 and 14 include a specific dimension 34 that corresponds to the desired setback length. Preferably, this dimension is either ¼ or 3/16 ths of an inch. However, it is within the contemplation of this invention that any desired setback distance can be obtained by merely providing a lip portion 12, 14 with the desired dimension 34.

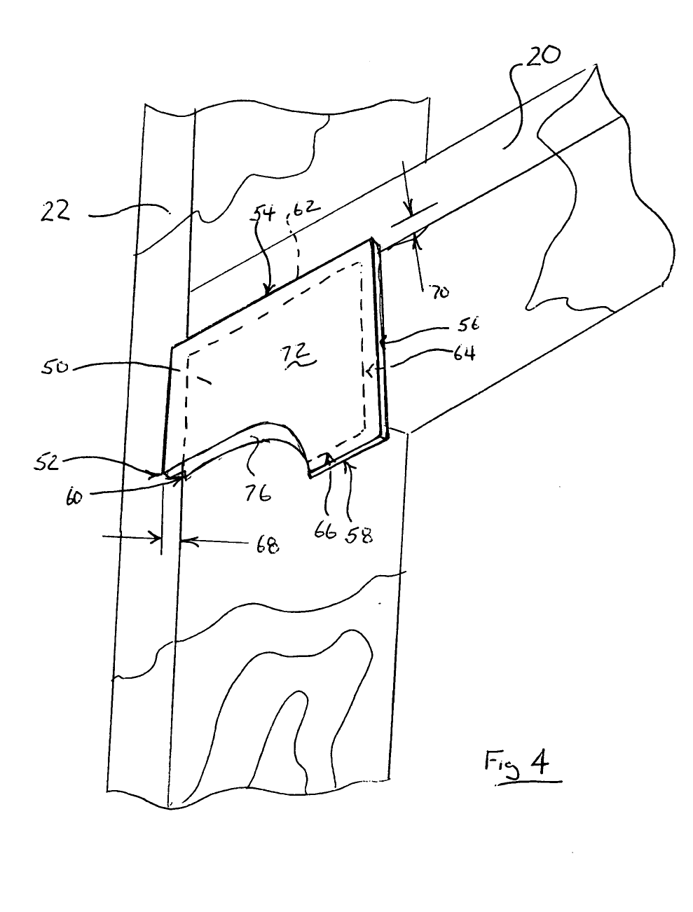

Referring to FIG. 4, another gauge 50 according to this invention includes first, second, third and fourth lips, 52, 54, 56, and 58 to add another degree of versatility and ease of use. As appreciated, in some instances a skilled carpenter may be required to hold and several different tools or marking devices. In some instances the hold of the gauge 50 may be backwards from the desired position. The additional lips provided on the gauge 50 allow the gauge 50 to be used in an additional orientation to further simplify use. The gauge includes four faces 60, 62, 64, and 66 corresponding to the four lips 52, 54, 56 and 58. Each of the faces 60, 62, 64, and 66 can abut the vertical and horizontal frame members 20,22 as required and still provide the desired set back distance 68.

A top surface 72 of the gauge 50 may include markings to indicate the specific set back distance for a specific gauge. Further, other identifiers as is desired can also be applied to this surface.

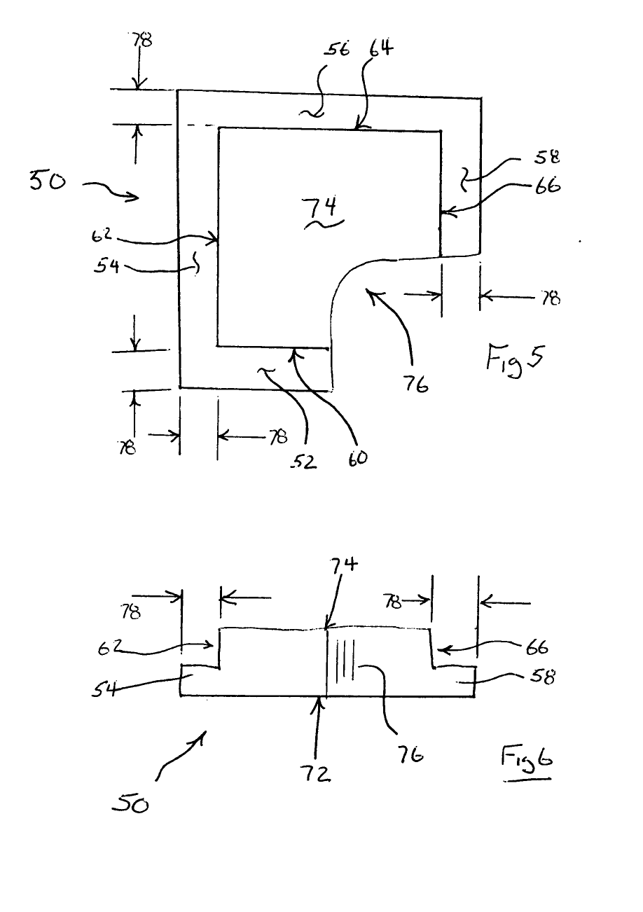

Referring to FIGS. 5 and 6, the gauge 50 is also a generally L-shaped block with a curved surface 76 disposed in the corner portion. FIG. 5, shows a bottom surface 74 of the gauge 50. The block includes faces 60, 62, 64 and 66 on four sides to allow the gauge 50 to be orientated between the vertical and horizontal members 20, 22 with the face 60 abutting an inner surface of the vertical member 22 and the face 62 abutting the horizontal member 20. Similarly, the face 66 can abut the vertical member 22 and the face 64 would then abut the horizontal member 20. As appreciated, the gauge 50 may also be placed such that the faces 62 and 64 abut corresponding vertical and horizontal frame members 20, 22.

The gauge 50 includes the four lips 52, 54, 56, and 58 that are all of a common width 78. The common width provides the desired set back distance and is preferably ¼ inch. Additionally, the common width 78 may also by 3/16ths of an inch. However, the specific set back distance may be as desired for the application specific requirements.

In use, this gauge 10 provides for simple operation and simple marking of the desired setback distance on the horizontal and vertical frame members 20, 22. The corners simply abut the first and second faces 14, 18 against the interior surface of the horizontal and vertical members 20, 22. A line or knifed edge is then marked onto the vertical and horizontal members 20, 22 to provide visual reference to which the trim molding should be assembled. The gauge of this invention provides a simple and economically cost efficient gauge for marking the desired setback distances for door and window frames.

The foregoing description is exemplary and not just a material specification. The invention has been described in an illustrative manner, and it should be understood that the technology used is intended to be in the nature of words of description rather than limitation. Many modifications and variations of the present invention are possible in light of the above teachings.

1. A gauge assembly for marking a set back distance for installation of trim comprising:
a first surface for abutment against a vertical member;
a second surface for abutment against a horizontal member concurrently with abutment against the vertical member; and
a lip extending perpendicularly from said first and second surfaces a length corresponding to a desired set back distance.

2. The assembly as recited in claim 1, wherein said lip extends a fixed distance from said first and second surfaces.

3. The assembly as recited in claim 1, wherein said first surface and said second surface are disposed at an angle of 90 degrees from each other.

4. The assembly as recited in claim 1, wherein said lip includes a first lip member extending from said first surface and a second lip portion extending from said second surface.

5. The assembly as recited in claim 4, wherein said first lip member and said second lip member are of an equal length from each of said first and second surfaces.

6. The assembly as recited in claim 5, wherein said equal length provides a set back distance of ¼ inch.

7. The assembly as recited in claim 5, wherein said equal length provides a set back distance of 3/16 of an inch.

8. The assembly as recited in claim 1, wherein said gauge is L-shaped.

9. The assembly as recited in claim 1, wherein a length of said lip is provided on top surface of said gauge assembly.

10. The assembly as recited in claim 1, including a bottom surface, said bottom surface forming a portion of said lip.

11. A gauge assembly for measuring a set back distance for trim, said assembly comprising:
a first abutment surface meeting a second abutment surface at a corner;
a lip member extending a length from said first and second abutments surfaces and said corner, wherein said length of said lip member from said first abutment surface, said second abutment surface and said corner provides a desired set back distance for the trim.

12. The assembly as recited in claim 11, wherein said gauge assembly is L-shaped and a surface opposite said corner comprises a curved surface.

13. The assembly as recited in claim 11, wherein said lip includes a marking surface disposed parallel relative to said first and second abutment surfaces.

14. The assembly as recited in claim 11, including a third abutment surface and a fourth abutment surface and said lip member includes a portion extending said length from said third and fourth abutment surfaces.

15. The assembly as recited in claim 14 including a notch between said first and second abutment surfaces.
